(19) United States
(12) Patent Application Publication
(10) Pub. No.: US 2024/0128437 A1
(43) Pub. Date: Apr. 18, 2024

(54) BATTERY AND METHOD FOR MANUFACTURING THE SAME

(71) Applicant: Panasonic Intellectual Property Management Co., Ltd., Osaka (JP)

(72) Inventors: SHUJI ITO, Nara (JP); TADAAKI MATSUMURA, Shiga (JP)

(21) Appl. No.: 18/542,602

(22) Filed: Dec. 16, 2023

Related U.S. Application Data
(63) Continuation of application No. PCT/JP2022/019753, filed on May 10, 2022.

(30) Foreign Application Priority Data
Jul. 7, 2021 (JP) 2021-113023

(51) Int. Cl. H01M 4/134; H01M 4/04; H01M 4/1395; H01M 4/38; H01M 4/62; H01M 10/0585

(52) U.S. Cl. CPC H01M 4/134; H01M 4/0404; H01M 4/0445; H01M 4/1395; H01M 4/386; H01M 4/625; H01M 10/0585; H01M 2004/027

(57) ABSTRACT

A battery includes a positive electrode, a negative electrode, and an electrolyte layer located between the positive electrode and the negative electrode. The negative electrode includes a negative electrode current collector and a negative electrode active material layer located between the negative electrode current collector and the electrolyte layer. The negative electrode active material layer includes a plurality of columnar bodies. The columnar bodies include silicon and a filler including a carbon material. The filler is embedded in the columnar bodies.

### BACKGROUND

### 1. Technical Field

The present disclosure relates to a battery and a method for manufacturing the same.

### 2. Description of the Related Art

Japanese Unexamined Patent Application Publication No. 2015-65173 discloses a negative electrode active material for nonaqueous electrolyte secondary batteries that includes a core portion including silicon and a surface layer present on part or the entirety of the surface of the core portion. In Japanese Unexamined Patent Application Publication No. 2015-65173, the surface layer includes carbon and titanium or aluminum.

WO 2017/056932 discloses a negative electrode active material that includes a silicon active material covered with conductive carbon. In WO 2017/056932, the negative electrode active material is used in a nonaqueous electrolyte secondary battery.

### SUMMARY

One non-limiting and exemplary embodiment provides a battery improved in cycle characteristics.

In one general aspect, the techniques disclosed here feature a battery including a positive electrode, a negative electrode, and an electrolyte layer located between the positive electrode and the negative electrode, wherein the negative electrode includes a negative electrode current collector and a negative electrode active material layer located between the negative electrode current collector and the electrolyte layer, the negative electrode active material layer includes a plurality of columnar bodies, the columnar bodies include silicon and a filler including a carbon material, and the filler is embedded in the columnar bodies.

The battery provided according to the present disclosure has improved cycle characteristics.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic sectional view of a battery according to an embodiment;

FIG. 2 is a schematic sectional view of a negative electrode according to the embodiment;

FIG. 3 is a flowchart of a method for manufacturing a battery according to the embodiment;

FIG. 4A is a scanning electron microscope (SEM) image of a cross section of a negative electrode in a battery of Sample 1;

FIG. 4B is an enlarged view of region IVB illustrated in FIG. 4A;

FIG. 4C is a graph illustrating results of elemental analysis at location IVC illustrated in FIG. 4B; and

FIG. 4D is a graph illustrating results of elemental analysis at location IVD illustrated in FIG. 4B.

### DETAILED DESCRIPTIONS

### Underlying Knowledge Forming Basis of the Present Disclosure

The development of automobile lithium secondary batteries having such characteristics as high safety, high performance, and long life is an urgent necessity in order to deal with the rapid spread of electric vehicles (EV). Furthermore, the extension in cruising distance per charge and the shortening of charging time are required in order to enhance EV convenience. In order for lithium secondary batteries to have high energy density or high capacity, importance lies in the development of negative electrode materials having high capacity. For example, silicon is a promising negative electrode material having high capacity. Unfortunately, it is difficult for negative electrode active materials including silicon to achieve both high capacity and excellent long-term cycle characteristics.

As described hereinabove, Japanese Unexamined Patent Application Publication No. 2015-65173 discloses a negative electrode active material that includes a core portion including silicon and a surface layer including carbon. WO 2017/056932 discloses a negative electrode active material that includes a silicon active material covered with conductive carbon. In the typical negative electrode active materials of Japanese Unexamined Patent Application Publication No. 2015-65173 and WO 2017/056932, silicon particles are covered with a coating layer including a carbon material. However, this configuration has a problem in that the carbon material cannot follow sufficiently a volume change of silicon when a battery is charged and discharged at high load. In the configuration of Unexamined Patent Application Publication No. 2015-65173 and WO 2017/056932, repeated charging and discharging of a battery can result in exposure of new silicon faces and consequent reaction of silicon with an electrolyte solution. Furthermore, the coating layer may come off from the silicon particles to cause a decrease in the function of the negative electrode active material. That is, the negative electrode active materials of Unexamined Patent Application Publication No. 2015-65173 and WO 2017/056932 tend to lower the capacity after repeated charging and discharging of a battery.

The present inventors studied approaches to improving cycle characteristics of batteries that have a negative electrode including silicon. As a result, the present inventors have newly found that cycle characteristics are advantageously improved by designing a negative electrode active material layer so that the negative electrode active material layer has columnar bodies including silicon, and a carbon material is localized at a plurality of locations within the negative electrode active material layer. The present inventors carried out further studies based on the newly found knowledge and have completed the battery of the present disclosure.

### SUMMARY OF ASPECTS OF THE PRESENT DISCLOSURE

A battery according to the first aspect of the present disclosure includes:
a positive electrode;
a negative electrode; and
an electrolyte layer located between the positive electrode and the negative electrode, wherein
the negative electrode includes a negative electrode current collector and a negative electrode active material layer located between the negative electrode current collector and the electrolyte layer,
the negative electrode active material layer includes a plurality of columnar bodies,
the columnar bodies include silicon and a filler including a carbon material, and
the filler is embedded in the columnar bodies.

According to the first aspect, the filler including a carbon material is embedded in the columnar bodies. Thus, the filler is unlikely to be detached from the columnar bodies even when the battery is repeatedly charged and discharged. The conductivity stemming from the filler is maintained, and the cycle characteristics of the battery are improved. In particular, the battery tends to have excellent long-term cycle characteristics. The battery also tends to have high capacity.

In the second aspect of the present disclosure, for example, the battery according to the first aspect may be such that the columnar bodies include a matrix surrounding the filler, and the matrix includes the silicon.

In the third aspect of the present disclosure, for example, the battery according to the first or the second aspect may be such that the negative electrode active material layer is essentially free from an electrolyte.

In the fourth aspect of the present disclosure, for example, the battery according to any one of the first to the third aspects may be such that the columnar bodies in the negative electrode active material layer are aligned along a surface of the negative electrode current collector.

In the fifth aspect of the present disclosure, for example, the battery according to any one of the first to the fourth aspects may be such that the columnar bodies include the silicon as a main component.

In the sixth aspect of the present disclosure, for example, the battery according to any one of the first to the fifth aspects may be such that the filler includes the carbon material as a main component.

In the seventh aspect of the present disclosure, for example, the battery according to any one of the first to the sixth aspects may be such that the carbon material includes at least one selected from the group consisting of carbon fibers and carbon blacks.

In the eighth aspect of the present disclosure, for example, the battery according to any one of the first to the seventh aspects may be such that the filler has a particulate shape.

In the ninth aspect of the present disclosure, for example, the battery according to any one of the first to the eighth aspects may be such that the columnar bodies further include a binder.

In the tenth aspect of the present disclosure, for example, the battery according to any one of the first to the ninth aspects may be such that the negative electrode current collector includes copper.

In the eleventh aspect of the present disclosure, for example, the battery according to any one of the first to the tenth aspects may be such that the electrolyte layer includes a solid electrolyte having lithium ion conductivity.

In the twelfth aspect of the present disclosure, for example, the battery according to any one of the first to the eleventh aspects may be such that the electrolyte layer includes a sulfide solid electrolyte.

The batteries according to the second to the twelfth aspects attain improved cycle characteristics. In particular, the batteries tend to have excellent long-term cycle characteristics. The batteries also tend to have high capacity.

A method for manufacturing a battery according to the thirteenth aspect of the present disclosure includes:
forming a thin film including silicon particles and a carbon material on a negative electrode current collector;
preparing a laminated body including the negative electrode current collector, the thin film, an electrolyte layer, and a positive electrode; and
forming a plurality of columnar bodies from the thin film by charging and discharging the laminated body, the columnar bodies including silicon and a filler including the carbon material.

According to the thirteenth aspect, a battery improved in cycle characteristics can be manufactured.

In the fourteenth aspect of the present disclosure, for example, the manufacturing method according to the thirteenth aspect may be such that the thin film is formed by applying a coating liquid including the silicon particles and the carbon material onto the negative electrode current collector and performing drying treatment.

In the fifteenth aspect of the present disclosure, for example, the manufacturing method according to the thirteenth or the fourteenth aspect may be such that the laminated body is charged and discharged while applying a pressure to the laminated body.

According to the fourteenth or the fifteenth aspect, a battery improved in cycle characteristics can be manufactured.

Hereinafter, an embodiment of the present disclosure will be described with reference to the drawings. The present disclosure is not limited to the embodiment described below.

### Embodiment

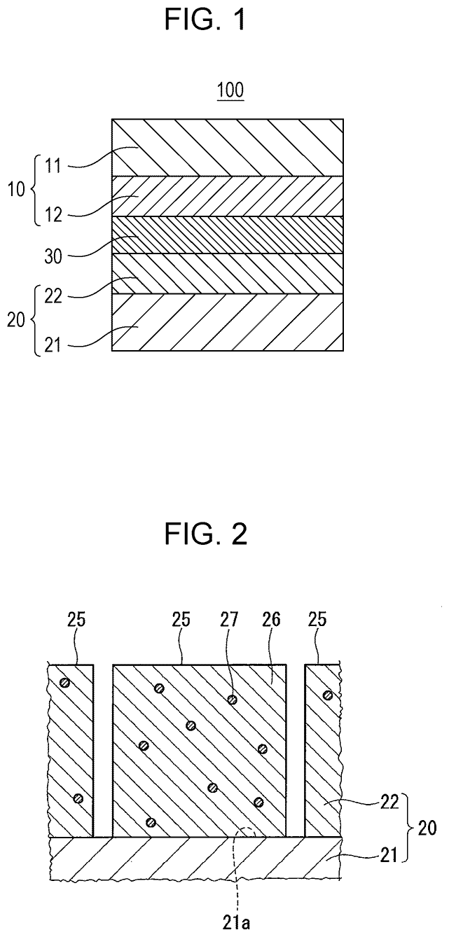

FIG. 1 is a schematic sectional view of a battery 100 according to an embodiment. As illustrated in FIG. 1, the battery 100 includes a positive electrode 10, a negative electrode 20, and an electrolyte layer 30. The electrolyte layer 30 is located between the positive electrode 10 and the negative electrode 20. The negative electrode 20 includes a negative electrode current collector 21 and a negative electrode active material layer 22. The negative electrode active material layer 22 is located between the negative electrode current collector 21 and the electrolyte layer 30.

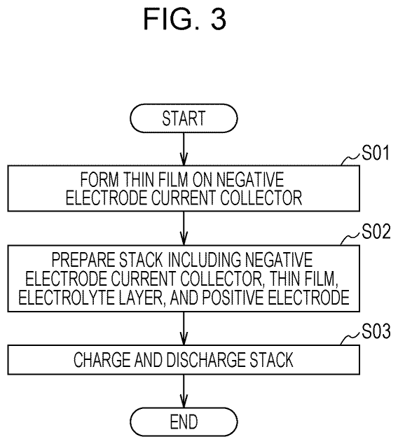

FIG. 2 is a schematic sectional view of the negative electrode 20 according to the present embodiment. As illustrated in FIG. 2, the negative electrode active material layer 22 includes a plurality of columnar bodies 25. The columnar bodies 25 include silicon and a filler 27 including a carbon material. The filler 27 is embedded in the columnar bodies 25. Specifically, the columnar bodies 25 include a matrix 26 surrounding the filler 27. The matrix 26 includes silicon.

In the present embodiment, the filler 27 is embedded within the columnar bodies 25. That is, a carbon material is localized at a plurality of locations within the columnar bodies 25. The silicon itself contained in the matrix 26 is a semiconductor and has poor electron conductivity. In the present embodiment, however, an electron conductive carbon material is present inside the columnar bodies 25 and thus the electron conductivity of the negative electrode active material layer 22 is enhanced. Silicon may form an alloy with lithium. Thus, the matrix 26 in the battery 100 may change its volume when silicon absorbs and releases lithium. In the present embodiment, the filler 27 is embedded in the columnar bodies 25 and is therefore unlikely to be detached from the columnar bodies 25 even when the volume of the matrix 26 changes significantly due to charging and discharging of the battery 100. In this manner, the negative electrode active material layer 22 can easily maintain conductivity, and the battery 100 attains improved cycle characteristics. In particular, the battery 100 tends to have excellent long-term cycle characteristics.

For example, the columnar bodies 25 are in contact with the negative electrode current collector 21 and extend in the thickness direction of the negative electrode current collector 21. The columnar bodies 25 may be inclined with respect to the thickness direction of the negative electrode current collector 21. The shape of the columnar bodies 25 may be prismatic or cylindrical.

In the present embodiment, the columnar bodies 25 in the negative electrode active material layer 22 are aligned along a surface 21a of the negative electrode current collector 21. That is, the surface 21a of the negative electrode current collector 21 is covered with the columnar bodies 25. The columnar bodies 25 may cover the entirety of the surface 21a of the negative electrode current collector 21 or may cover part of the surface 21a. A gap may be present between any two adjacent columnar bodies 25 among the columnar bodies 25.

For example, the negative electrode active material layer 22 is composed of a plurality of columnar bodies 25. The negative electrode active material layer 22 is typically a collection of a plurality of columnar bodies 25 covering the surface of the negative electrode current collector 21. For example, the negative electrode active material layer 22 is a single layer composed of a plurality of columnar bodies 25. According to the negative electrode active material layer 22 of the present embodiment, the electrolyte layer 30 and the negative electrode current collector 21 are unlikely to come into direct contact with each other, and the battery 100 can attain high energy density more reliably.

As described above, the columnar bodies 25 include the matrix 26 and the filler 27. The filler 27 is embedded in the matrix 26. The filler 27 is surrounded by the matrix 26. The filler 27 is dispersed in the matrix 26. In FIG. 2, masses of the filler 27 are separate from one another. Masses of the filler 27 may be in contact with one another. In the columnar bodies 25, for example, the filler 27 is in close contact with the matrix 26. At least part of the surface of the filler 27 is in contact with the matrix 26. As an example, the entire surface of the filler 27 is in contact with the matrix 26. For example, there are essentially no voids or cracks between the matrix 26 and the filler 27. In other words, for example, the columnar bodies 25 have a dense structure.

In the matrix 26, for example, silicon forms a continuous phase. In this case, Li ion conduction pathways are formed in the continuous silicon phase. In other words, Li ion conduction pathways are ensured inside the columnar bodies 25. Because of the conduction pathways, the negative electrode active material layer 22 can easily conduct Li ions through the inside thereof. It is, however, not necessary that all the silicon in the matrix 26 form a continuous phase. In the matrix 26, some silicon may form discontinuous phases. In the matrix 26, silicon may be present essentially as elemental silicon.

The matrix 26 may include amorphous silicon. In the present disclosure, the term “amorphous” is not limited to indicating that the substance is completely free from crystal structures, but also means that the substance may have a short-range order crystalline region. For example, an amorphous substance is a substance that does not show a sharp peak assigned to a crystal and shows a broad peak assigned to an amorphous phase in X-ray diffractometry (XRD). In the present disclosure, the phrase “include amorphous silicon” means that at least part of the matrix 26 is composed of amorphous silicon. In the present embodiment, all the silicon present in the matrix 26 may be amorphous.

The matrix 26 may be free from crystalline silicon. The matrix 26 may be essentially composed solely of amorphous silicon. The matrix 26 being essentially composed solely of amorphous silicon can be determined in the following manner First, XRD measurement is performed with respect to randomly selected portions (for example, 50 portions) of the negative electrode active material layer 22. When the portions that are measured do not show a sharp peak at all, the matrix 26 can be judged as being essentially composed solely of amorphous silicon.

For example, the matrix 26 includes silicon as a main component. In the present specification, the term “main component” means that the component represents the largest mass ratio among all the components. The matrix 26 may essentially include only silicon. The phrase “essentially include only silicon” permits mixing of trace amounts of incidental impurities. The matrix 26 may include a binder described later. The presence of silicon in the matrix 26 can be confirmed by elemental analysis, such as energy-dispersive X-ray spectroscopy (EDX).

Because of the matrix 26, in the present embodiment, the negative electrode active material layer 22 may include silicon as a main component, and the columnar bodies 25 may include silicon as a main component. From the point of view of energy density, the content of silicon in the negative electrode active material layer 22 may be greater than or equal to 80 mass % or may be greater than or equal to 95 mass %. The upper limit of the content of silicon in the negative electrode active material layer 22 is not particularly limited and is, for example, 99 mass %, and may be 95 mass % in some cases. The content of silicon in the columnar bodies 25 may be greater than or equal to 80 mass % or may be greater than or equal to 95 mass %. The upper limit of the content of silicon in the columnar bodies 25 is not particularly limited and is, for example, 99 mass %, and may be 95 mass % in some cases. With the above configuration, the initial discharge capacity of the battery 100 can be enhanced. For example, the content of silicon can be determined by inductively coupled plasma (ICP) emission spectroscopy.

The content of the matrix 26 in the columnar bodies 25 is not particularly limited and is, for example, greater than or equal to 80 mass %, and may be greater than or equal to 95 mass %. The upper limit of the content of the matrix 26 in the columnar bodies 25 is not particularly limited and is, for example, 99 mass %, and may be 95 mass % in some cases.

The carbon material contained in the filler 27 imparts electron conductivity to the columnar bodies 25. Thus, the electron conductivity of the negative electrode active material layer 22 can be enhanced. Examples of the carbon materials include graphites, carbon blacks, and carbon fibers. The carbon material may include at least one selected from the group consisting of carbon fibers and carbon blacks.

Examples of the graphites include natural graphites and artificial graphites. Examples of the carbon blacks include acetylene blacks, furnace blacks, and Ketjen blacks. Examples of the carbon fibers include vapor-grown carbon fibers (VGCF (registered trademark)) and carbon nanotubes. These materials may be used singly, or two or more may be used in combination.

For example, the filler 27 includes the carbon material as a main component. The filler 27 may essentially include only the carbon material. The filler 27 may include a binder described later. The presence of the carbon material in the filler 27 can be confirmed by elemental analysis, such as EDX.

Because of the filler 27, the negative electrode active material layer 22 in the present embodiment includes the carbon material. The content of the carbon material in the negative electrode active material layer 22 may be less than or equal to 10 mass % from the points of view of energy density and rate characteristics. The carbon material is poor in ion conductivity and tends to inhibit the conduction of Li ions. Thus, the content of the carbon material may be less than or equal to 5 mass %. The above configuration can ensure excellent cycle characteristics over a long period of time while reducing the decrease in energy density of the battery 100. The lower limit of the content of the carbon material in the negative electrode active material layer 22 is not particularly limited and is, for example, 0.5 mass %, and may be 1 mass %. For example, the content of the carbon material can be determined by a combustion-infrared absorption method.

The content of the filler 27 in the columnar bodies 25 is not particularly limited and is, for example, less than or equal to 10 mass %, and may be less than or equal to 5 mass %. The lower limit of the content of the filler 27 in the columnar bodies 25 is not particularly limited and is, for example, 0.5 mass %, and may be 1 mass %.

The shape of the filler 27 is not particularly limited. For example, the filler 27 has a particulate shape. The shape of the filler 27 may be other shape, such as acicular, spherical, ellipsoidal, or fibers. When the filler 27 has a particulate shape, the average particle size of the filler 27 is, for example, greater than or equal to 10 nm and less than or equal to 1000 nm. The average particle size of the filler 27 can be determined in the following manner First, a cross section of the negative electrode active material layer 22 is observed with a scanning electron microscope (SEM). The cross section of the negative electrode active material layer 22 is one that is parallel to the thickness direction of the negative electrode active material layer 22. The SEM image obtained is analyzed to calculate the area of a particular particle of the filler 27 by image processing. The diameter of a circle having the same area as the calculated area is taken as the particle diameter of the particular particle of the filler 27. The particle diameter is calculated with respect to a predetermined number (for example, 50) of particles of the filler 27, and the calculated values are averaged to give the average particle size of the filler 27.

The columnar bodies 25 may further include a binder. Specifically, at least one selected from the group consisting of the matrix 26 and the filler 27 may include a binder. The binder can enhance the integrity of the materials constituting the columnar bodies 25.

Examples of the binders include polyvinylidene fluoride, polytetrafluoroethylene, polyethylene, polypropylene, aramid resins, polyimide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene butadiene rubber, and carboxymethylcellulose. Furthermore, the binder that is used may be a copolymer of two or more materials selected from the group consisting of tetrafluoroethylene, hexafluoroethylene, hexafluoropropylene, perfluoroalkyl vinyl ethers, vinylidene fluoride, chlorotrifluoroethylene, ethylene, propylene, pentafluoropropylene, fluoromethyl vinyl ether, acrylic acid, and hexadiene. The binders may be used singly, or two or more may be used in combination.

An elastomer may be used as the binder. Elastomer means a polymer having elasticity. The elastomer used as the binder may be a thermoplastic elastomer or a thermosetting elastomer. The binder may include a thermoplastic elastomer. Examples of the elastomers include styrene-ethylene/butylene-styrene block copolymer (SEBS), styrene-ethylene/propylene-styrene block copolymer (SEPS), styrene-ethylene/ethylene/propylene-styrene block copolymer (SEEPS), butylene rubber (BR), isoprene rubber (IR), chloroprene rubber (CR), acrylonitrile-butadiene rubber (NBR), styrene-butylene rubber (SBR), styrene-butadiene-styrene block copolymer (SBS), styrene-isoprene-styrene block copolymer (SIS), hydrogenated isoprene rubber (HIR), hydrogenated butyl rubber (HIIR), hydrogenated nitrile rubber (HNBR), and hydrogenated styrene-butylene rubber (HSBR). A mixture of two or more selected from those described above may be used as the binder.

The content of the binder in the columnar bodies 25 is not particularly limited and is, for example, less than or equal to 10 mass %, and may be less than or equal to 5 mass %. The lower limit of the content of the binder in the columnar bodies 25 is not particularly limited and is, for example, 0.1 mass %.

The negative electrode active material layer 22 may essentially include only silicon, the carbon material, and the binder. The phrase “essentially include only silicon, the carbon material, and the binder” permits mixing of trace amounts of incidental impurities. The negative electrode active material layer 22 may further include incidental impurities, or starting materials, by-products, and decomposition products that are used or occur in the formation of the negative electrode active material layer 22. For example, the negative electrode active material layer 22 may include oxygen or a dissimilar metal.

During repeated charging and discharging of the battery 100, part of the material forming the negative electrode current collector 21 may move to the negative electrode active material layer 22. Thus, the negative electrode active material layer 22 may further include a metal of origin from the negative electrode current collector 21 as an additional component other than silicon, the carbon material, and the binder. For example, this metal may be copper, nickel, stainless steel, or an alloy containing the foregoing metal as a main component. As an example, the negative electrode active material layer 22 may be such that the surface of the columnar bodies 25 is covered with a coating layer including a metal of origin from the negative electrode current collector 21. For example, this coating layer covers part of the surface of the columnar bodies 25. The matrix 26 of the columnar bodies 25 may include a metal of origin from the negative electrode current collector 21.

For example, the negative electrode active material layer 22 is essentially free from an electrolyte. In the present specification, the term “electrolyte” includes solid electrolyte and nonaqueous electrolyte. The phrase “essentially free from” permits mixing of a trace amount of an electrolyte. In particular, the negative electrode active material layer 22 may be essentially free from an electrolyte after the fabrication of the battery 100 and before the initial charging and discharging of the battery 100. According to the above configuration, the battery 100 has high energy density due to the high content of silicon in the negative electrode active material layer 22. Furthermore, according to the above configuration, the essential absence of an electrolyte, for example, a solid electrolyte, such as a sulfide solid electrolyte, in the negative electrode active material layer 22 may reduce or eliminate contacts between the metal in the negative electrode current collector 21 and a sulfide solid electrolyte. As a result, no or little sulfides are generated by charging and discharging of the battery 100, and the battery 100 can maintain rate characteristics and cycle characteristics over a long period of time.

During repeated charging and discharging of the battery 100, part of the material forming the electrolyte layer 30 may move to the negative electrode active material layer 22. Thus, the negative electrode active material layer 22 may further include an electrolyte of origin from the electrolyte layer 30. For example, this electrolyte is a solid electrolyte. As an example, the mass of the electrolyte mixed from the electrolyte layer 30 into the negative electrode active material layer 22 is variable depending on the number of charge-discharge cycles but is, for example, less than or equal to 10 mass % relative to the total mass of the negative electrode active material layer 22.

For example, the thickness of the negative electrode active material layer 22 is greater than or equal to 4 μm. The upper limit of the thickness of the negative electrode active material layer 22 may be 30 μm or may be 10 μm. With the above configuration, the battery 100 can attain a small decrease from the initial discharge capacity. The thickness of the negative electrode active material layer 22 can be determined in the following manner First, a cross section of the negative electrode active material layer 22 is observed with a scanning electron microscope (SEM). The cross section of the negative electrode active material layer 22 is one that is parallel to the thickness direction of the negative electrode active material layer 22. With respect to the SEM image obtained, 50 portions of the negative electrode active material layer 22 are randomly selected. The thickness is measured of the randomly selected 50 portions of the negative electrode active material layer 22. The measured values are averaged to give the thickness of the negative electrode active material layer 22.

In the negative electrode active material layer 22, the width of the columnar bodies 25 is, for example, greater than or equal to 3 μm and less than or equal to 30 μm. The width of the columnar bodies 25 indicates the length of the columnar bodies 25 in a direction perpendicular to the direction in which the negative electrode current collector 21 and the negative electrode active material layer 22 are laminated. The width of the columnar bodies 25 can be determined in the following manner First, a cross section of the negative electrode active material layer 22 is observed with a scanning electron microscope (SEM). The cross section of the negative electrode active material layer 22 is one that is parallel to the thickness direction of the negative electrode active material layer 22. With respect to the SEM image obtained, fifty columnar bodies 25 are randomly selected. The maximum width is measured of each of the randomly selected fifty columnar bodies 25. The measured values are averaged to give the width of the columnar bodies 25.

The material of the negative electrode current collector 21 is typically a metal. For example, the material of the negative electrode current collector 21 may be copper, nickel, stainless steel, or an alloy containing the foregoing metal as a main component. The negative electrode current collector 21 may include at least one selected from the group consisting of copper and nickel, or may include copper. The negative electrode current collector 21 may include copper or nickel as a main component, or may include copper as a main component. According to the above configuration, the battery 100 attains high energy density more reliably.

From the points of view of electron conductivity and cost, the negative electrode current collector 21 may be composed of copper or a copper alloy. For example, copper forms copper sulfide by reacting with a sulfide solid electrolyte. In general, copper sulfide is a substance that may be a resistance in ion conduction. In the battery 100 according to the present embodiment, the negative electrode active material layer 22 is essentially free from an electrolyte, such as, for example, a solid electrolyte. In other words, there are essentially no electrolytes on the surface of the negative electrode current collector 21. Thus, the battery 100 according to the present embodiment experiences no or little reaction between the metal contained in the negative electrode current collector 21 and an electrolyte. Thus, even when the negative electrode current collector 21 is composed of copper or a copper alloy, charging and discharging of the battery 100 are unlikely to form, for example, copper sulfide. As described above, the battery 100 according to the present embodiment can use a negative electrode current collector 21 including copper.

A metal foil may be used as the negative electrode current collector 21. Examples of the metal foils include copper foils. The copper foil may be an electrolytic copper foil. For example, an electrolytic copper foil can be produced in the following manner First, a metal drum is immersed into an electrolyte solution in which copper ions are dissolved. An electric current is applied to the drum while rotating the drum. In this manner, copper is deposited onto the surface of the drum. The deposited copper is peeled to give an electrolytic copper foil. One side or both sides of the electrolytic copper foil may be roughened or surface-treated.

The surface of the negative electrode current collector 21 may be roughened or may not be roughened. The surface-roughened negative electrode current collector 21 tends to allow the columnar bodies 25 to be formed easily on the negative electrode current collector 21. Furthermore, the surface roughening also tends to enhance the adhesion between the columnar bodies 25 and the negative electrode current collector 21. For example, the surface of the negative electrode current collector 21 may be roughened by electrolytically depositing a metal to form a rough surface of the metal.

For example, the arithmetic average roughness Ra of the surface of the negative electrode current collector 21 is greater than or equal to 0.001 μm. The arithmetic average roughness Ra of the surface of the negative electrode current collector 21 may be greater than or equal to 0.01 μm and less than or equal to 1 μm or may be greater than or equal to 0.1 μm and less than or equal to 0.5 μm. Appropriate control of the arithmetic average roughness Ra of the surface of the negative electrode current collector 21 can increase the area of contacts between the negative electrode current collector 21 and the negative electrode active material layer 22. In this manner, it is possible to reduce or eliminate the occurrence of separation of the negative electrode active material layer 22 from the negative electrode current collector 21. As a result, the battery 100 may attain high cycle characteristics more reliably. The arithmetic average roughness Ra is a value specified in Japanese Industrial Standards (JIS) B0601: 2013 and can be measured with, for example, a laser microscope.

The thickness of the negative electrode current collector 21 is not particularly limited and may be greater than or equal to 5 μm and less than or equal to 50 μm or may be greater than or equal to 8 μm and less than or equal to 25 μm.

The electrolyte layer 30 is a layer including an electrolyte. For example, the electrolyte is a solid electrolyte. That is, the electrolyte layer 30 may be a solid electrolyte layer.

For example, the electrolyte layer 30 includes a solid electrolyte having lithium ion conductivity. Examples of the solid electrolytes contained in the electrolyte layers 30 include sulfide solid electrolytes, oxide solid electrolytes, halide solid electrolytes, complex hydride solid electrolytes, and polymeric solid electrolytes. With this configuration, the battery 100 can attain both high capacity and excellent cycle characteristics. The electrolyte layer 30 may include a sulfide solid electrolyte.

Examples of the sulfide solid electrolytes include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂. LiX, Li₂O, MOₚ, or Li_{q}MOᵣ may be added to the solid electrolytes described above. X includes at least one selected from the group consisting of F, Cl, Br, and I. M is at least one selected from the group consisting of P, Si, Ge, B, Al, Ga, In, Fe, and Zn. The letters p, q, and r are each a natural number.

Examples of the oxide solid electrolytes include Na super ionic conductor (NASICON)-type solid electrolytes typified by LiTi₂(PO₄)₃ and element-substituted derivatives thereof; perovskite-type solid electrolytes including (LaLi)TiO₃; Li super ionic conductor (LISICON)-type solid electrolytes typified by Li₁₄ZnGe₄O₁₆, Li₄SiO₄, LiGeO₄, and element-substituted derivatives thereof; garnet-type solid electrolytes typified by Li₇La₃Zr₂O₁₂ and element-substituted derivatives thereof; Li₃N and H-substituted derivatives thereof; Li₃PO₄ and N-substituted derivatives thereof; and glass and glass ceramics based on Li—B—O compound, such as LiBO₂ or Li₃BO₃, and doped with, for example, Li₂SO₄ or Li₂CO₃.

Examples of the halide solid electrolytes include materials represented by the compositional formula Li_{α}M_{β}X_{γ}, α, β, and γ are each independently a value greater than 0. M includes at least one selected from the group consisting of metal elements except Li, and metalloid elements. X is one, or two or more elements selected from the group consisting of F, Cl, Br, and I. The metalloid elements are B, Si, Ge, As, Sb, and Te. The metal elements are all the elements found in Groups 1 to 12 of the periodic table except hydrogen, and all the elements found in Groups 13 to 16 of the periodic table except B, Si, Ge, As, Sb, Te, C, N, P, O, S, and Se. That is, the metalloid elements or the metal elements are a group of elements that can form an inorganic compound with a halogen compound by becoming a cation.

Specific examples of the halide solid electrolytes include Li₃YX₆, Li₂MgX₄, Li₂FeX₄, Li(Al,Ga,In)X₄, and Li₃ (Al,Ga,In)X₆. In the present disclosure, “(Al,Ga,In)” indicates at least one element selected from the group consisting of the elements in parentheses. That is, “(Al,Ga,In)” is synonymous with “at least one selected from the group consisting of Al, Ga, and In”. The same applies to other elements.

Examples of the complex hydride solid electrolytes include LiBH₄—LiI and LiBH₄—P₂S₅.

Examples of the polymeric solid electrolytes include compounds of a polymer compound with a lithium salt. The polymer compound may have an ethylene oxide structure. The polymer compound having an ethylene oxide structure can contain a large amount of a lithium salt, and thus the ionic conductivity can be further increased. Examples of the lithium salts include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. The lithium salts may be used singly, or two or more may be used in combination.

For example, the shape of the solid electrolyte is particulate. The shape of the solid electrolyte may be other shape, such as acicular, spherical, or ellipsoidal. When the solid electrolyte is particles, the average particle size is, for example, greater than or equal to 0.1 μm and less than or equal to 50 μm.

The positive electrode 10 includes a positive electrode current collector 11 and a positive electrode active material layer 12. The positive electrode active material layer 12 is located between the positive electrode current collector 11 and the electrolyte layer 30.

The material of the positive electrode current collector 11 is not limited to a particular material and may be a material commonly used in batteries. Examples of the materials of the positive electrode current collectors 11 include copper, copper alloys, aluminum, aluminum alloys, stainless steel, nickel, titanium, carbon, lithium, indium, and conductive resins. The shape of the positive electrode current collector 11 is not limited to a particular shape. Examples of the shapes include foils, films, and sheets. The surface of the positive electrode current collector 11 may have irregularities.

For example, the positive electrode active material layer 12 includes a positive electrode active material. For example, the positive electrode active material includes a material capable of occluding and releasing metal ions, such as lithium ions. Examples of the positive electrode active materials include lithium-containing transition metal oxides, transition metal fluorides, polyanion materials, fluorinated polyanion materials, transition metal sulfides, transition metal oxysulfides, and transition metal oxynitrides.

Examples of the lithium-containing transition metal oxides include Li(Ni,Co,Al)O₂, Li(Ni,Co,Mn)O₂, and LiCoO₂. In particular, the use of a lithium-containing transition metal oxide as the positive electrode active material advantageously saves the cost of production of the battery 100 and increases the average discharge voltage of the battery 100. To increase the energy density of the battery 100, the positive electrode active material may include lithium nickel cobalt manganese oxide. For example, the positive electrode active material may be Li(Ni,Co,Mn)O₂.

Where necessary, the positive electrode active material layer 12 may further include at least one selected from the group consisting of solid electrolytes, conductive materials, and binders. The positive electrode active material layer 12 may include a mixed material including positive electrode active material particles and solid electrolyte particles.

For example, the shape of the positive electrode active material is particulate. When the positive electrode active material is particles, the average particle size of the positive electrode active material is, for example, greater than or equal to 100 nm and less than or equal to 50 μm.

The average charge-discharge potential of the positive electrode active material versus the redox potential of Li metal may be greater than or equal to 3.7 V vs. Li/Li⁺. For example, the average charge-discharge potential of the positive electrode active material can be determined by averaging the voltages applied to extract and insert Li from and into the positive electrode active material while using Li metal as the counter electrode. When a material other than Li metal is used as the counter electrode, the average potential can be determined by adding the potential of the counter electrode material versus Li metal to the charge-discharge curves. When a material other than Li metal is used as the counter electrode, the battery may be charged and discharged at a relatively low current in consideration of ohmic loss.

At least one selected from the group consisting of the positive electrode 10 and the electrolyte layer 30 may include a binder for the purpose of enhancing the adhesion of particles to one another. For example, binders are used to enhance the integrity of materials constituting an electrode. For example, the binders used here may be those described hereinabove with respect to the negative electrode active material layer 22.

The positive electrode 10 may include a conductive auxiliary for the purpose of enhancing the electron conductivity. Examples of the conductive auxiliaries include graphites, carbon blacks, conductive fibers, carbon fluoride, metal powders, conductive whiskers, conductive metal oxides, and conductive polymers. Examples of the graphites include natural graphites and artificial graphites. Examples of the carbon blacks include acetylene blacks and Ketjen blacks. Examples of the conductive fibers include carbon fibers and metal fibers. Examples of the metal powders include aluminum. Examples of the conductive whiskers include zinc oxide and potassium titanate. Examples of the conductive metal oxides include titanium oxide. Examples of the conductive polymer compounds include polyaniline, polypyrrole, and polythiophene. The cost can be reduced by using a conductive auxiliary containing carbon.

Examples of the shapes of the batteries 100 include coin shapes, cylindrical shapes, prismatic shapes, sheet shapes, button shapes, flat shapes, and laminate shapes.

The operating temperature of the battery 100 is not particularly limited. For example, the operating temperature is higher than or equal to −50° C. and lower than or equal to 100° C. With increasing operating temperature of the battery 100, the ion conductivity can be enhanced and the battery 100 tends to be capable of high-output operation.

For example, the area of the principal face of the battery 100 is greater than or equal to 1 cm² and less than or equal to 100 cm². In this case, for example, the battery 100 can be used in portable electronic devices, such as smartphones and digital cameras. The area of the principal face of the battery 100 may be greater than or equal to 100 cm² and less than or equal to 1000 cm². In this case, for example, the battery 100 can be used as a power supply for large movable machines, such as electric vehicles. The “principal face” means the face of the battery 100 that has the largest area.

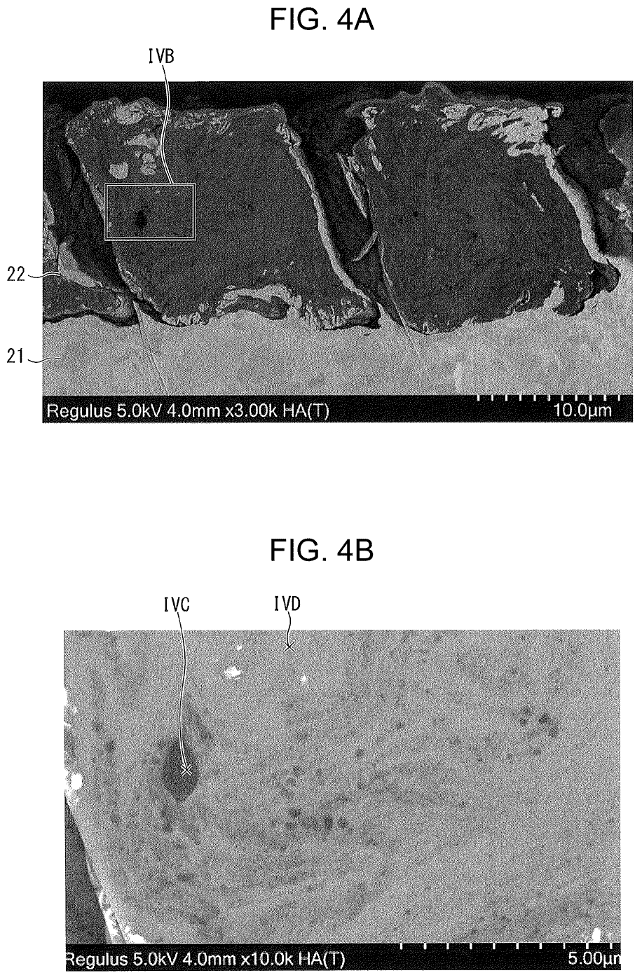

For example, the battery 100 according to the present embodiment may be manufactured by the following method. FIG. 3 is a flowchart of a method for manufacturing a battery 100.

First, in Step S01, a thin film including silicon particles and a carbon material is formed on a negative electrode current collector 21. The silicon particles may include amorphous silicon or crystalline silicon. The silicon particles may include polycrystalline silicon. The average particle size of the silicon particles is not particularly limited and is, for example, greater than or equal to 0.01 μm and less than or equal to 10 μm. The average particle size of the silicon particles means the particle size at 50% cumulative volume in the volume-based grain size distribution (the median diameter). The volume-based grain size distribution may be determined by a laser diffraction scattering method. The mass of silicon per area of the thin film is not particularly limited and is, for example, greater than or equal to 0.2 mg/cm² and less than or equal to 5 mg/cm². The carbon material used here may be one described hereinabove with respect to the filler 27.

The thin film may include a binder in addition to the silicon particles and the carbon material. The binder used here may be one described hereinabove with respect to the negative electrode active material layer 22. The thin film may essentially include only the silicon particles, the carbon material, and the binder. The thin film may be essentially free from an electrolyte.

The thin film may be formed by any method without limitation. For example, the following method may be adopted. First, a coating liquid containing silicon particles and a carbon material is prepared. For example, the coating liquid includes an organic solvent, such as N-methylpyrrolidone (NMP). The coating liquid may further include the binder described hereinabove. The coating liquid may be a paste. Next, the coating liquid prepared is applied onto the negative electrode current collector 21, and the resultant coating film is subjected to drying treatment to form a thin film. The conditions for the drying treatment of the coating film can be determined appropriately in accordance with factors, such as the type of the solvent contained in the coating liquid. As an example, the temperature of the drying treatment may be higher than or equal to 80° C. and lower than or equal to 150° C. The drying treatment time may be greater than or equal to 1 hour and less than or equal to 24 hours.

Next, in Step S02, a laminated body is prepared that includes the negative electrode current collector 21, the thin film, an electrolyte layer 30, and a positive electrode 10. For example, this laminated body can be prepared in the following manner. First, a solid electrolyte powder is added to an electrically insulating cylinder. The solid electrolyte powder is pressed to form an electrolyte layer 30. Next, the structure composed of the negative electrode current collector 21 and the thin film is added into the cylinder. The inside of the cylinder is pressed to form a laminated body having the negative electrode current collector 21, the thin film, and the electrolyte layer 30. Next, a positive electrode active material powder and a positive electrode current collector 11 are added into the cylinder. The inside of the cylinder is pressed to form a laminated body including the negative electrode current collector 21, the thin film, the electrolyte layer 30, and a positive electrode 10. Alternatively, a positive electrode active material powder and a positive electrode current collector 11 may be added into the cylinder together with the structure composed of the negative electrode current collector 21 and the thin film, and the inside of the cylinder may be pressed to form a laminated body. In the laminated body, the negative electrode current collector 21, the thin film, the electrolyte layer 30, and the positive electrode 10 are laminated in this order.

Next, the inside of the electrically insulating cylinder is isolated from the outside atmosphere and is sealed with use of an electrically insulating ferrule. Next, in Step S03, the laminated body is charged and discharged. By this charging and discharging, the silicon particles in the thin film are bound to one another, and a plurality of columnar bodies 25 are formed. That is, a negative electrode active material layer 22 is formed from the thin film by charging and discharging. A battery 100 can be thus obtained.

In Step S03, the charging and discharging may be performed while applying a pressure to the laminated body. For example, the pressure is applied in the same direction as the direction in which the layers are laminated. The pressure applied to the laminated body is not particularly limited and is, for example, greater than or equal to 50 MPa and less than or equal to 300 MPa.

### Examples

The present disclosure will be described in detail below using examples and comparative example. The electrode materials and the batteries of the present disclosure are not limited to the following examples.

### Sample 1

### Preparation of Thin Film

First, a 10 μm thick electrolytic copper foil was provided as a negative electrode current collector. Next, 1 g of a powder of silicon particles having an average particle size of 2.5 μm, 0.04 g of vapor-grown carbon fibers (VGCF) as a carbon material, and 1 g of an N-methylpyrrolidone (NMP) solution containing polyvinylidene fluoride (PVDF) as a binder were mixed together. The silicon particles were composed of polycrystalline silicon. The concentration of PVDF in the NMP solution was 5 mass %. NMP was further added to the mixture, and the resultant mixture was mixed in a mortar to give a pasty coating liquid. The coating liquid obtained was applied onto the negative electrode current collector with a coater. The coating film thus obtained was subjected to drying treatment at 100° C. for 12 hours. A structure composed of the negative electrode current collector and a thin film was thus obtained. In Sample 1, the mass of silicon per area of the thin film was 1.03 mg/cm².

### Preparation of Sulfide Solid Electrolyte Material

In an argon atmosphere glove box having a dew point of less than or equal to −60° C., Li₂S and P₂S₅ were weighed out in a mortar so that the molar ratio Li₂S:P₂S₅ would be 75:25. These were pulverized and mixed in the mortar to give a mixture. The mixture obtained was added to planetary ball mill P-7 manufactured by Fritsch Japan Co., Ltd. and was milled at 510 rotations per minute (rpm) for 10 hours to give a glass-like solid electrolyte. The glass-like solid electrolyte was heat-treated at 270° C. for 2 hours in an inert gas atmosphere. Thus, glass-ceramic solid electrolyte Li₂S—P₂S₅ was obtained.

### Preparation of Positive Electrode Mixture

LiNi_{0.8}Co_{0.1}Mn_{0.1} as a positive electrode active material and the sulfide solid electrolyte were weighed out so that the mass ratio positive electrode active material:sulfide solid electrolyte would be 85:15. The materials were mixed in a mortar. A positive electrode mixture was thus obtained.

### Preparation of Laminated Body

80 mg of the solid electrolyte was weighed out, added to an electrically insulating cylinder, and compacted at 50 MPa to form an electrolyte layer. Next, the positive electrode mixture was added onto the electrolyte layer so that the mass of the positive electrode active material would be 13.3 mg. Furthermore, the above-described structure that had been punched out to a diameter of 9.4 mm was placed on the other side of the electrolyte layer, and the unit was pressed at 370 MPa. Thus, a laminated body was obtained that included the negative electrode current collector, the thin film, the electrolyte layer, and a positive electrode. Next, current collectors including stainless steel were placed onto the positive electrode and the negative electrode, and current collector leads were attached to the current collectors. Next, the inside of the electrically insulating cylinder was isolated from the outside atmosphere and was sealed with use of an electrically insulating ferrule. The laminated body was sandwiched vertically between substrates, and four bolts were tightened so as to apply a pressure of 150 MPa to the laminated body. Thus, a laminated body of Sample 1 was obtained.

### Charge-Discharge Test

Next, the laminated body of Sample 1 was subjected to a charge-discharge test under the following conditions. In the charge-discharge test, the laminated body was placed in a thermostatic chamber at 25° C.

### Evaluation of Initial Charge and Discharge Capacities

The laminated body of Sample 1 was charged at a constant current corresponding to 20-hour rate (0.05 C rate) to a voltage of 4.2 V. Next, the laminated body was discharged at a current corresponding to 0.05 C rate to a voltage of 2.0 V. By the charging and discharging of the laminated body, a negative electrode active material layer was formed from the thin film. A battery was thus obtained. The initial discharge capacity obtained was converted to a value per mass of silicon and to a value per unit area of the negative electrode active material layer. The results are described in Table 1.

### Evaluation of Charge-Discharge Cycle Characteristics

After the evaluation of the initial charge and discharge capacities, the battery was tested to evaluate charge-discharge cycle characteristics. Specifically, a cycle of charging and discharging was repeated under the above conditions nineteen times. In the twentieth and later cycles, the battery was charged at a constant current of 0.3 C rate to 4.2 V and was further charged at a constant voltage of 4.2 V until the current attenuated to 0.05 C. The battery was discharged at a current of 0.3 C rate to 2.0 V. These charging and discharging operations were repeated until the 500th cycle was reached. The ratio of the discharge capacity in the 500th cycle to the discharge capacity in the 20th cycle was determined as the capacity retention rate. The results are described in Table 1.

### Observation of Cross Section of Negative Electrode

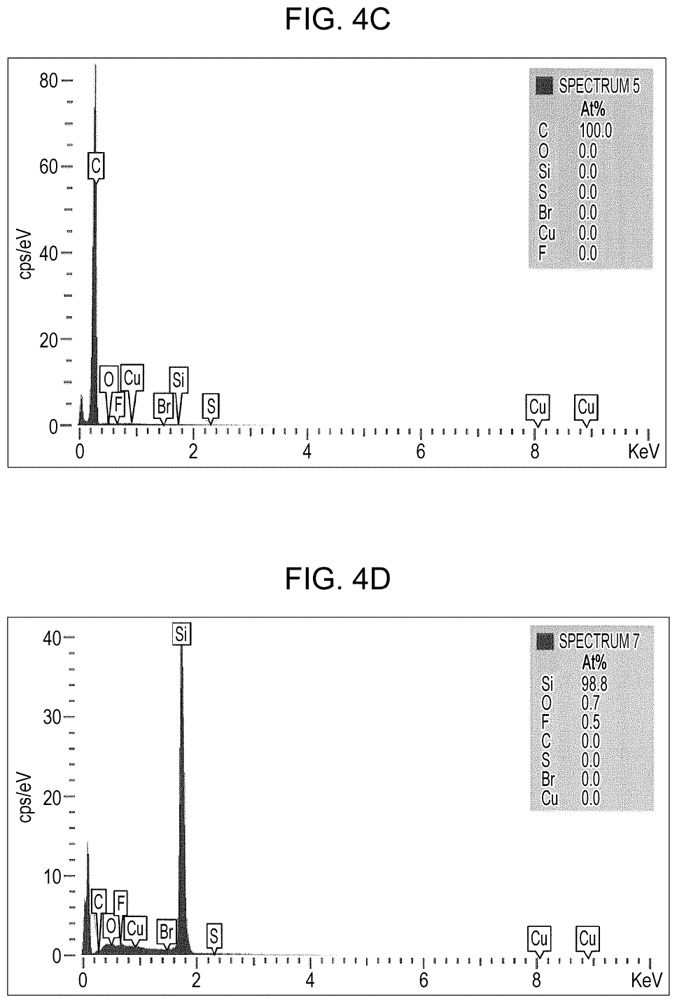

After the evaluation of charge-discharge cycle characteristics, the negative electrode of the battery of Sample 1 was cut and the cross section thereof was observed. FIG. 4A is a scanning electron microscope (SEM) image of the cross section of the negative electrode in the battery of Sample 1. FIG. 4B is an enlarged view of region IVB illustrated in FIG. 4A. FIG. 4C is a graph illustrating results of elemental analysis at location IVC illustrated in FIG. 4B. FIG. 4D is a graph illustrating results of elemental analysis at location IVD illustrated in FIG. 4B. FIGS. 4C and 4D illustrate elemental spectra obtained by the elemental analysis.

As can be seen from FIG. 4A, the negative electrode active material layer in the battery of Sample 1 was composed of a plurality of columnar bodies. As can be seen from FIG. 4B, the columnar bodies included a matrix and a filler. As can be seen from FIG. 4C, the filler included a carbon material. As can be seen from FIG. 4D, the matrix included silicon. The carbon material was localized at a plurality of locations within the columnar bodies. There were no voids between the matrix and the filler in the columnar bodies. That is, the columnar bodies had a dense structure.

### Sample 2

A laminated body of Sample 2 was prepared in the same manner as in Sample 1, except that the mass of VGCF as the carbon material was changed to 0.02 g. In Sample 2, the mass of silicon per area of the thin film was 1.00 mg/cm².

### Sample 3

A laminated body of Sample 3 was prepared in the same manner as in Sample 1, except that the carbon material was changed to acetylene black. In Sample 3, the mass of silicon per area of the thin film was 1.02 mg/cm².

### Sample 4

A laminated body of Sample 4 was prepared in the same manner as in Sample 1, except that the carbon material was changed to furnace black. In Sample 4, the mass of silicon per area of the thin film was 1.03 mg/cm².

### Sample 5

A laminated body of Sample 5 was prepared in the same manner as in Sample 1, except that the carbon material was not used. In Sample 5, the mass of silicon per area of the thin film was 1.00 mg/cm².

### Charge-Discharge Test

The laminated bodies of Samples 2 to 5 were charge-discharge tested in the same manner as in Sample 1. The results are described in Table 1.

TABLE 1

| | | | | Capacity |
|---|---|---|---|---|
| | | Initial discharge capacity | | retention |
| Sample | Carbon material | [mAh/g] | [mAh/cm²] | rate [%] |
| 1 | Vapor-grown carbon | 2376 | 3.70 | 85 |
| | fibers | | | |
| 2 | Vapor-grown carbon | 2486 | 3.73 | 75 |
| | fibers | | | |
| 3 | Acetylene black | 2411 | 3.69 | 84 |
| 4 | Furnace black | 2373 | 3.67 | 78 |
| 5 | None | 2462 | 3.71 | 72 |

As can be seen from Table 1, the batteries of Samples 1 to 5 had an initial discharge capacity per unit area of the negative electrode active material layer of approximately 3.7 mAh/cm². Similarly, the batteries of Samples 1 to 5 had an initial discharge capacity per mass of silicon of approximately 2400 mAh/g. In Samples 1 to 4, the columnar bodies in the negative electrode active material layer included the carbon material as the filler. The batteries of Samples 1 to 4 achieved a discharge capacity retention rate of greater than or equal to 75% and outperformed the battery of Sample 5 in which the columnar bodies did not contain any carbon material filler. From these results, the batteries according to the present embodiment have improved cycle characteristics.

For example, the battery of the present disclosure may be used as an automobile lithium ion secondary battery.

What is claimed is:

1. A battery comprising:
a positive electrode;
a negative electrode; and
an electrolyte layer located between the positive electrode and the negative electrode, wherein
the negative electrode includes a negative electrode current collector and a negative electrode active material layer located between the negative electrode current collector and the electrolyte layer,
the negative electrode active material layer comprises a plurality of columnar bodies,
the columnar bodies comprise silicon and a filler comprising a carbon material, and
the filler is embedded in the columnar bodies.

2. The battery according to claim 1, wherein
the columnar bodies comprise a matrix surrounding the filler, and
the matrix comprises the silicon.

3. The battery according to claim 1, wherein
the negative electrode active material layer is essentially free from an electrolyte.

4. The battery according to claim 1, wherein
the columnar bodies in the negative electrode active material layer are aligned along a surface of the negative electrode current collector.

5. The battery according to claim 1, wherein
the columnar bodies comprise the silicon as a main component.

6. The battery according to claim 1, wherein
the filler comprises the carbon material as a main component.

7. The battery according to claim 1, wherein
the carbon material comprises at least one selected from the group consisting of carbon fibers and carbon blacks.

8. The battery according to claim 1, wherein
the filler has a particulate shape.

9. The battery according to claim 1, wherein
the columnar bodies further comprise a binder.

10. The battery according to claim 1, wherein
the negative electrode current collector comprises copper.

11. The battery according to claim 1, wherein
the electrolyte layer comprises a solid electrolyte having lithium ion conductivity.

12. The battery according to claim 1, wherein
the electrolyte layer comprises a sulfide solid electrolyte.

13. A method for manufacturing a battery, comprising:
forming a thin film comprising silicon particles and a carbon material on a negative electrode current collector;
preparing a laminated body including the negative electrode current collector, the thin film, an electrolyte layer, and a positive electrode; and
forming a plurality of columnar bodies from the thin film by charging and discharging the laminated body, the columnar bodies comprising silicon and a filler comprising the carbon material.

14. The manufacturing method according to claim 13, wherein
the thin film is formed by applying a coating liquid including the silicon particles and the carbon material onto the negative electrode current collector and performing drying treatment.

15. The manufacturing method according to claim 13, wherein
the laminated body is charged and discharged while applying a pressure to the laminated body.
